(19) United States
(12) Patent Application Publication
(10) Pub. No.: US 2025/0288950 A1
(43) Pub. Date: Sep. 18, 2025

(54) COMPRESSED AIR RESERVOIR, COMPRESSED AIR SYSTEM AND METHOD FOR THE OPERATION THEREOF

(71) Applicant: AMK Holding GmbH & Co. KG, Aichwald (DE)

(72) Inventor: Philipp Schaible, Roemerstein Donnstetten (DE)

(73) Assignee: AMK Holding GmbH & Co. KG, Aichwald (DE)

(21) Appl. No.: 19/079,773

(22) Filed: Mar. 14, 2025

(30) Foreign Application Priority Data
Mar. 15, 2024 (DE) 10 2024 107 532.5
Aug. 21, 2024 (DE) 10 2024 123 925.5

(51) Int. Cl. B01D 53/26; B01D 53/04; B60G 11/27

(52) U.S. Cl. CPC B01D 53/261; B01D 53/0446; B01D 2253/106; B01D 2257/80; B01D 2258/06; B01D 2259/40086; B01D 2259/4566; B60G 11/27; B60G 2202/152; B60G 2600/66

(57) ABSTRACT

A compressed air reservoir for a compressed air system, in particular an air spring system or compressed air-based sensor cleaning system of a motor vehicle is disclosed. The compressed air reservoir is configured to at least temporarily store compressed air generated by a compressor device, wherein the compressed air reservoir has a reservoir housing which forms an interior space for storing the compressed air which is controllably fluidically decouplable by way of at least one valve device. The compressed air reservoir includes an air drying device structurally integrated into the compressed air reservoir and holding a desiccant for drying the compressed air. Compressed air systems with the compressed air reservoir and a methods for operating the compressed air reservoir are also disclosed.

### CROSS REFERENCE TO RELATED APPLICATIONS

The present disclosure claims the priority benefit of German Patent Application No. 10 2024 107 532.5, filed Mar. 15, 2024 and the priority benefit of German Patent Application No. 10 2024 123 925.5, filed Aug. 21, 2024, the entire contents of both are incorporated herein in their respective entireties.

### FIELD

The present disclosure relates to compressed air systems, and more particularly, to a compressed air reservoir for a compressed air system.

### BACKGROUND OF THE PRESENT DISCLOSURE

Compressed air reservoirs are typically part of a compressed air system, often of an air spring system or a compressed air-based sensor cleaning system for motor vehicles or the like. Such a compressed air system conventionally has a compressor device, usually a compressor, which serves to generate compressed air. The compressed air system furthermore has at least one compressed air device which is filled or operated with the compressed air generated by the compressor device. In the case of an air spring system, the compressed air device is for example an air spring gallery (being a compressed air gallery with attached air springs) with a plurality of air springs, each of which is associated with a wheel and which, for lifting or providing adjustable suspension of the corresponding wheel of a motor vehicle in which the air spring system is installed, provides adjustable suspension or spring stiffness, or adjusts the motor vehicle's suspension characteristics by filling with or venting compressed air. The compressor device is fluidically coupled to the compressed air device to ensure this function.

A compressed air reservoir can be connected between the compressor device and the compressed air device in order to make a supply of compressed air available on demand without having to set the compressor device in operation. This is utilized, for example, if the compressed air device requires only a small quantity of compressed air for which fully starting up the compressor device would be inefficient or dynamically too sluggish, or if the compressor device is currently not operational, for example, due to a lack of fuel/electricity or due to malfunction. The compressed air reservoir thus offers the advantage of being able to store compressed air as required and enable reliable operation of the compressed air system.

Air, and thus compressed air, naturally contains a certain amount of moisture. If this moisture gets into the compressed air system, it can have a not insignificant negative impact on the compressed air system, at least in the medium to long term, and in particular even in the short term. This is because the penetration of moisture into the compressed air system, which is typically closed, is associated with a risk of corrosion and/or frost and thus damage and malfunctioning of the compressed air system.

In the light of the disadvantages discussed above, there is therefore a significant need to ensure reliable drying of the compressed air.

### SUMMARY

In an aspect, a compressed air reservoir for a compressed air system of a motor vehicle includes a reservoir housing forming an interior space for storing compressed air which is controllably fluidically decouplable, via a valve, from a compressor. The reservoir includes an air drying device structurally integrated into the compressed air reservoir and holding a desiccant for drying the compressed air.

In another aspect, a compressed air system for a motor vehicle includes a compressor device for generating compressed air, a compressed air reservoir fluidly coupled to the compressor device for at least temporary storage of the compressed air, and a compressed air device fluidly coupled to the compressed air reservoir and/or the compressor device. The compressed air reservoir includes a reservoir housing forming an interior space and an air drying device structurally integrated into the compressed air reservoir and holding a desiccant for drying the compressed air. The compressed air device is configured to fill with compressed air.

In yet another aspect, a method for operating a compressed air reservoir includes generating compressed air by a compressor device, transmitting the compressed air to the compressed air reservoir for at least temporary storage in the compressed air reservoir, and drying the compressed air by a air drying device arranged within an interior space of the compressed air reservoir. The interior space is defined by a reservoir housing of the compressed air reservoir. The air drying device is structurally integrated in the compressed air reservoir.

### BRIEF DESCRIPTION OF THE DRAWINGS

Further advantages are revealed by the present description of the drawings. The drawings show exemplary embodiments of the present disclosure. The drawings, description and claims contain numerous features in combination. A person skilled in the art will expediently also consider the features individually and combine them into meaningful further combinations.

FIG. 1A is a schematic representation of a compressed air system according to an apsect of the present disclosure;

FIG. 1B is a schematic representation of a compressed air-based sensor cleaning system according to an aspect of the present disclosure;

FIG. 2A depicts a schematic perspective representation of an embodiment of an air drying device of the compressed air reservoir according to an aspect of the present disclosure;

FIG. 2B depicts a schematic sectional representation of the air drying device of FIG. 2A;

FIG. 3 depicts a circuit diagram of one embodiment of a compressed air system according to FIG. 1A in an initial state;

FIG. 4A depicts the circuit diagram of FIG. 3 in a first operating state of the compressed air system;

FIG. 4B depicts the circuit diagram of FIG. 3 in a second operating state of the compressed air system;

FIG. 4C depicts the circuit diagram of FIG. 3 in a third operating state of the compressed air system;

FIG. 4D depicts the circuit diagram of FIG. 3 in a fourth operating state of the compressed air system;

FIG. 4E depicts the circuit diagram of FIG. 3 in a fifth operating state of the compressed air system;

FIG. 4F depicts the circuit diagram of FIG. 3 in a sixth operating state of the compressed air system; and

FIG. 5 depicts a circuit diagram of the compressed air-based sensor cleaning system according to FIG. 1B in an initial state.

Identical elements are denoted with the same reference signs in the figures. The figures are merely illustrative and should not be understood as being limiting.

### DETAILED DESCRIPTION

The present disclosure relates to a compressed air reservoir for a compressed air system, in particular an air spring system or compressed air-based sensor cleaning system, of a motor vehicle, wherein the compressed air reservoir is configured to at least temporarily store compressed air generated by a compressor device, in particular a compressor, wherein the compressed air reservoir has a reservoir housing which forms an interior space for storing the compressed air which is controllably fluidically decouplable, e.g., by way of at least one valve device.

The present disclosure further relates to a compressed air system having such a compressed air reservoir.

The present disclosure additionally relates to a method for operating a compressed air reservoir or compressed air system.

It is known to add an air drying device to the compressed air system in order prevent (excessive) penetration of moisture and thus the formation of condensation within the compressed air system. Known air drying devices are conventionally independent or structurally separate components that have their own housing accommodating a desiccant, usually silica pellets.

The desiccant has the characteristic of binding moisture present in the air flowing through it and so drying or dehumidifying the air. The air drying device with its desiccant acts as a moisture filter.

Within the compressed air system, the air drying device is conventionally arranged fluidically immediately downstream of or following the compressor device in order to dehumidify the generated and heated compressed air directly or immediately upstream of further distribution within the compressed air system and so prevent the penetration of moisture to the greatest possible extent from the outset.

It is important to note that the desiccant only has a certain temperature range within which it can reliably perform its drying function. This temperature range is typically between 0° C. and 80° C. Only if the temperature of the compressed air to be dried is within this temperature range is the desiccant capable of absorbing and storing sufficient moisture from the compressed air, such that efficient drying can only be ensured within this temperature window.

However, considerably higher temperatures are regularly reached when the compressor device compresses air to generate compressed air such that, on outflow from the compressor device or inflow into the downstream air drying device, the compressed air has a distinctly higher temperature than is required for optimum functionality of the desiccant. This is because, due to the comparatively short distance involved, there is too little time for the compressed air to cool down sufficiently in the time between outflow from the compressor device and inflow into the air drying device.

Conventional arrangements of the air drying device immediately following the compressor device is not particularly advantageous, as the high temperature of the generated compressed air increases the risk that the air drying device will only be able to fulfill its actual drying function to a limited extent.

In addition, the arrangement of the air drying device immediately downstream of the compressor device has the further disadvantage that the air drying device is located in a flowing region within which the compressed air is flowing comparatively quickly through the air drying device. The compressed air can thus only interact with the desiccant for a relatively short period of time, which further impairs the dehumidification of the compressed air.

The object of the present disclosure is to provide an improved solution, in particular with regard to the arrangement of the air drying device, to ensure reliable and sufficient drying of the compressed air.

This object is achieved by a compressed air reservoir, a compressed air system and a method according to the independent claims. Advantageous embodiments of the present disclosure constitute the subject matter of the subclaims.

As noted herein, the present disclosure is based on a compressed air reservoir for a compressed air system, in particular an air spring system or compressed air-based sensor cleaning system, of a motor vehicle, wherein the compressed air reservoir is configured to at least temporarily store compressed air generated by a compressor device, in particular a compressor, wherein the compressed air reservoir has a reservoir housing which forms an interior space for storing the compressed air which is controllably fluidically decouplable, e.g., by way of at least one valve device.

The present disclosure provides that the compressed air reservoir has an air drying device structurally integrated into the compressed air reservoir and holding a desiccant, in particular silica pellets, for drying the compressed air.

In other words, the present disclosure provides that the air drying device is not, as in solutions known from the prior art, configured as a component that is structurally separate from or independent of the compressed air reservoir and may be situated at a different location within the corresponding compressed air system than the compressed air reservoir and is connectable to the latter by way of a piping system. Instead, in the present case, the present disclosure provides that the air drying device is a part or a sub-element of the compressed air reservoir which is structurally integrated into the latter and is arranged in the region of the compressed air reservoir or in the interior thereof. Within the compressed air reservoir, the air drying device is still an independently operable element which can advantageously also be configured housing-free.

Advantageously, the integration provided according to the present disclosure of the air drying device into the compressed air reservoir enables distinctly improved drying potential for the compressed air generated by the compressor device. This is because, in contrast with hitherto known solutions, the air drying device is not arranged immediately following the compressor device, but at a more distant location. In this way, the compressed air can cool before it comes into contact with the air drying device, such that its temperature on (initial) contact with the desiccant is within the functional temperature range of the desiccant and thus the latter's drying function can be reliably ensured. Since the compressed air is intended to be kept in the compressed air reservoir for a certain storage or residence time, integrating or arranging the air drying device in the compressed air reservoir furthermore also ensures a sufficient residence time of the compressed air in the desiccant's region of action, such that the drying function or drying potential is further increased. In addition, the compressed air can cool down further as it remains in the compressed air reservoir, such that drying potential is still further improved.

The positioning according to the present disclosure of the air drying device not immediately spatially adjacent to the compressor device but rather in the compressed air reservoir is thus particularly advantageous for use of the desiccant or for ensuring satisfactory drying of the compressed air. In comparison with known solutions, it offers better utilization of the functionality of the desiccant and consequently better drying and a certain flexibility with regard to the required quantity of desiccant.

Advantageously, independent regeneration of the air drying device or the desiccant is additionally enabled (active regeneration). This is because, in contrast with known solutions, in order to discharge the moisture stored in the desiccant, there is no longer any need to release compressed air present in the compressed air system, in particular in the air springs, as is in particular the case when lowering the air springs, but instead compressed air stored in the compressed air reservoir or freshly generated compressed air can be put to purposeful use, such that the (previously passive) regeneration process is not accompanied by any further impairment of the compressed air system, for example pressure loss in the air springs and thus lowering of the vehicle.

In the context of the present disclosure, fluidically decouplable means that fluidic isolation from the surroundings is enabled when required. Specifically, the interior space of the compressed air reservoir is isolatable or fluidically decouplable from the remainder of the compressed air system such that the intended storage of the compressed air therein is ensured.

In the context of the present disclosure, drying means removing moisture or dehumidifying the compressed air by way of the desiccant, in particular by the desiccant pellets. In the present case, the moisture removed from the compressed air is stored or absorbed in the desiccant such that the compressed air is dehumidified or dried. Drying takes place when the compressed air is held/stored in the compressed air reservoir and/or when it flows through/out of the compressed air reservoir into a downstream, fluidically couplable compressed air device (which is operated with the compressed air), for example an air spring gallery with a plurality air springs or a compressed air-based sensor cleaning system.

The reservoir housing has an air inlet fluidically couplable to the compressor device and an air outlet couplable to a downstream compressed air device, in particular air spring gallery. In particular, the inlet and outlet each have at least one controllable pneumatic switching valve.

A further development provides that the air drying device occupies no more than 30%, no more than 25%, or no more than 10% of a volume of an interior space of the compressed air reservoir. This advantageously ensures both sufficient drying and, at the same time, sufficient storage capacity for the compressed air.

A further development provides that the air drying device is arranged, in particular suspended, e.g., centrally, in the interior space and/or arranged in the vicinity of, in particular surrounding, a controllable compressed air inlet or compressed air outlet, in particular outside a throughflow region for the compressed air, and/or in that the air drying device is arranged within an air outflow path of a vent outlet of the compressed air reservoir. In other words, it is provided that the air drying device is substantially freely suspended in the internal volume such that the compressed air can advantageously flow through the desiccant from all sides and can thus be particularly reliably dried. When in intended service, the compressed air reservoir usually has a throughflow path which is the shortest path from the air inlet to the air outlet. The arrangement of the air drying device outside this path advantageously results in better drying, since an extended residence time of the compressed air in the region of action of the desiccant is ensured. The desiccant is arranged at or around a controllable compressed air inlet or compressed air outlet as a vent channel which is configured to dehumidify the desiccant, i.e., to regenerate the desiccant.

A further development provides that the air drying device is cylindrical in shape with at least one vent channel arranged axially and open toward a cylinder upper side and with a drying wall formed by the closed cylinder underside and by the radial cylinder outer wall. The cylindrical shape advantageously enables a particularly large contact surface with the compressed air and a large volume of desiccant that can be flowed through, such that sufficient drying is reliably ensured. The vent channel offers the further advantage that, when regeneration of the desiccant is required, the moisture stored therein can be reliably discharged via the vent channel. Furthermore, for regeneration purposes, the air drying device can be particularly straightforwardly coupled by way of the vent channel to a corresponding venting device, in particular an air drain and/or vent valve.

A further development provides that the air drying device is configured without a closed outer housing and thus housing-free. The air drying device thus does not have its own delimiting or separating housing, the desiccant instead being directly exposed to the interior space and thus to the compressed air located there. Advantageously, on the one hand, reliable drying is ensured and, on the other, the air drying device is particularly simple and therefore inexpensive to manufacture.

A further development provides that, to form a predefined shape, in particular cylindrical shape, of the air drying device, the desiccant, in particular in the form of silica pellets, is press-molded or baked into a predefined shape or is introduced and/or arranged in a matrix manner in a shaping, air-permeable envelope, in particular a fine-meshed net or grating. The net may be dimensionally stable but may optionally also be dimensionally flexible. In this context, shaping or dimensionally stable means that the predefined shape of the envelope is predetermined, i.e., the envelope brings the desiccant into the predetermined shape or maintains it in this shape. The predefined shape, as already mentioned above, can be cylindrical. Alternatively, however, a spherical, cubic, toroidal (doughnut-shaped) or similar shape can also be provided. Compression molding and/or baking to form the predefined shape advantageously enables particularly simple and inexpensive production of the air drying device. The same applies when the envelope is used, wherein this has the additional advantage that the predefined shape is reliably and durably retained and furthermore the desiccant can be easily replaced in the event of wear and the envelope reused.

A further development provides that the air drying device has an (additional) internally formed, e.g., axially arranged, desiccant-free vent channel which is fluidically connected to a vent outlet of the compressed air reservoir. In particular, this vent channel is the vent channel previously mentioned above. Alternatively, it may be a further or additional vent channel. Advantageously, the vent channel enables purposeful outward transport of the moisture during regeneration of the air drying device since the moisture collects at a predefined point or emerges from the desiccant there.

A further development provides that, for regenerating the desiccant and outward transport of moisture stored in the air drying device, the vent channel is controllably fluidically couplable, e.g., by way of an outlet valve connected to the vent outlet of the compressed air reservoir, to the atmosphere outside the compressed air reservoir, such that the air drying device is controllably regenerable. The process described by the term regeneration is known from the prior art, it being regularly necessary, when the desiccant is saturated, to outwardly transport the moisture stored therein in order to maintain the functionality of and to regenerate the desiccant. The provided coupling of the vent channel with the atmosphere allows the moisture stored in the desiccant to be “blown off”, i.e., active regeneration of the desiccant. When in intended service, the air drying device is spatially arranged or oriented in the reservoir in such a way that the vent channel is located in the direction of flow of the compressed air from the interior space to the atmosphere. Advantageously, the stored moisture can be particularly efficiently discharged.

A further development provides that the compressed air reservoir has, at a bottom region, a corrosion-resistant moisture collection device for collecting condensed moisture from the air drying device and which is fluidically connected to a dehumidification outlet of the compressed air reservoir. The collected moisture may have condensed on the internal wall of the reservoir housing and have dripped or flowed down from there to the moisture collection device. Especially if the air drying device is saturated, moisture can also drip down directly from the air drying device to the moisture collection device. Advantageously, the moisture collection device in conjunction with the dehumidification outlet enables purposeful collection and discharge of the condensed or collected moisture, such that drying and dewatering of the compressed air located in the compressed air reservoir is reliably ensured and unwanted moisture is removable from the compressed air reservoir.

A further development provides that bottom region has a convex inner contour. The convex inner contour forms the bottom region or advantageously purposefully forms a collection point where the condensed moisture would collect (puddle) due to gravity, such that the moisture is particularly reliably collectable and can then be discharged to dewater the reservoir.

A further development provides that the compressed air reservoir has or is connectable to a dehumidification valve, in particular pressure relief valve, that is controllably couplable to the moisture collection device, such that the condensed moisture collected in the moisture collection device can be controllably discharged from the compressed air reservoir, in particular in the event of overpressure in the compressed air reservoir. Advantageously, the collected moisture can be efficiently discharged. In particular, in a case of a pressure-controlled dehumidification valve, discharge is particularly simple and efficient as, from a certain level of pressurization, the condensed moisture is “pressed out” of the compressed air reservoir. Alternatively, no less advantageous purposeful control (magnetic, electric, etc.) of the dehumidification valve can be provided.

A secondary aspect of the present disclosure relates to a compressed air system, in particular an air spring system or compressed air-based sensor cleaning system, for a motor vehicle, having a compressor device, in particular compressor, for generating compressed air, a compressed air reservoir fluidically couplable to the compressor device for at least temporary storage of the compressed air, and a compressed air device, in particular air spring gallery or compressed air-based sensor cleaning gallery, which is fluidically couplable to the compressed air reservoir and/or the compressor device for filling with compressed air.

It is proposed that the compressed air reservoir is configured according to the present disclosure as described above. This results in the advantages previously stated in this connection.

A further development provides that the compressed air reservoir is fluidically interposed between the compressor device and the compressed air device. The air drying device is thus interposed between the compressor device and the compressed air device such that, once generated, the compressed air firstly passes into the compressed air reservoir where it is dried, wherein, due to the previously stated distance to the compressor device and the residence time in the compressed air reservoir, the compressed air can cool down sufficiently and interact with the desiccant for drying. This results in the advantages already stated above in this connection.

A further secondary aspect of the present disclosure relates to a method for operating a compressed air reservoir, in particular the compressed air reservoir according to the present disclosure described further above, of a compressed air system, in particular the compressed air system according to the present disclosure described above, wherein compressed air generated by a compressor device, in particular compressor, is at least temporarily stored in the compressed air reservoir.

It is proposed that, during storage in the compressed air reservoir or on flowing through the compressed air reservoir, the compressed air is dried by a, e.g., housing-free, air drying device which is in particular arranged in an interior space serving to store the compressed air and formed by a reservoir housing of the compressed air reservoir and is structurally integrated in the compressed air reservoir. This results in the advantages previously stated in this connection.

A further development provides that, for regenerating the air drying device, the air drying device, in particular a vent channel of the air drying device, is fluidically coupled, in particular by way of an outlet valve connected to a vent outlet of the compressed air reservoir, to an atmosphere located outside the compressed air reservoir and is flowed through with compressed air toward the atmosphere, such that moisture stored in the air drying device is discharged in controlled manner from the air drying device into the atmosphere and the desiccant is regenerated. This results in the advantages previously stated in this connection.

A further development provides that moisture condensed in the compressed air reservoir is collected in a moisture collection device, in particular arranged in a bottom region of the interior space, which bottom region, during intended service of the compressed air reservoir, is low in relation to the Earth's gravitational force, wherein, for discharge of the collected condensed moisture from the compressed air reservoir, the moisture collection device is coupled to a dehumidification valve, in particular pressure relief valve, wherein, e.g., by exposing the compressed air reservoir to overpressure, the collected condensed moisture from the moisture collection device is controllably transported outward via the dehumidification valve. This results in the advantages previously stated in this connection.

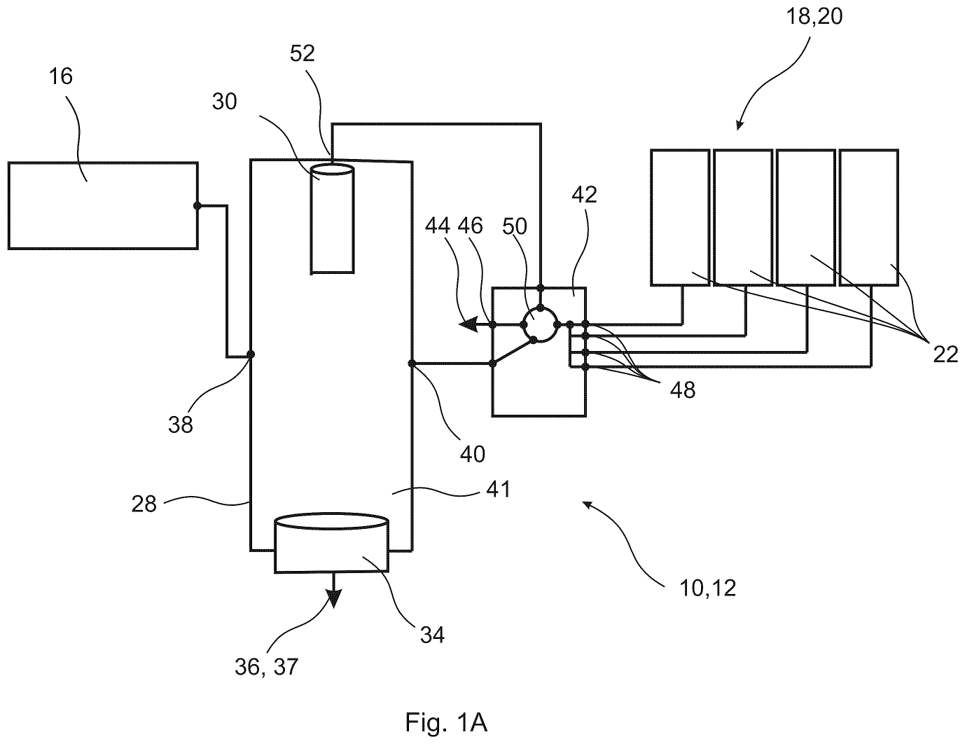

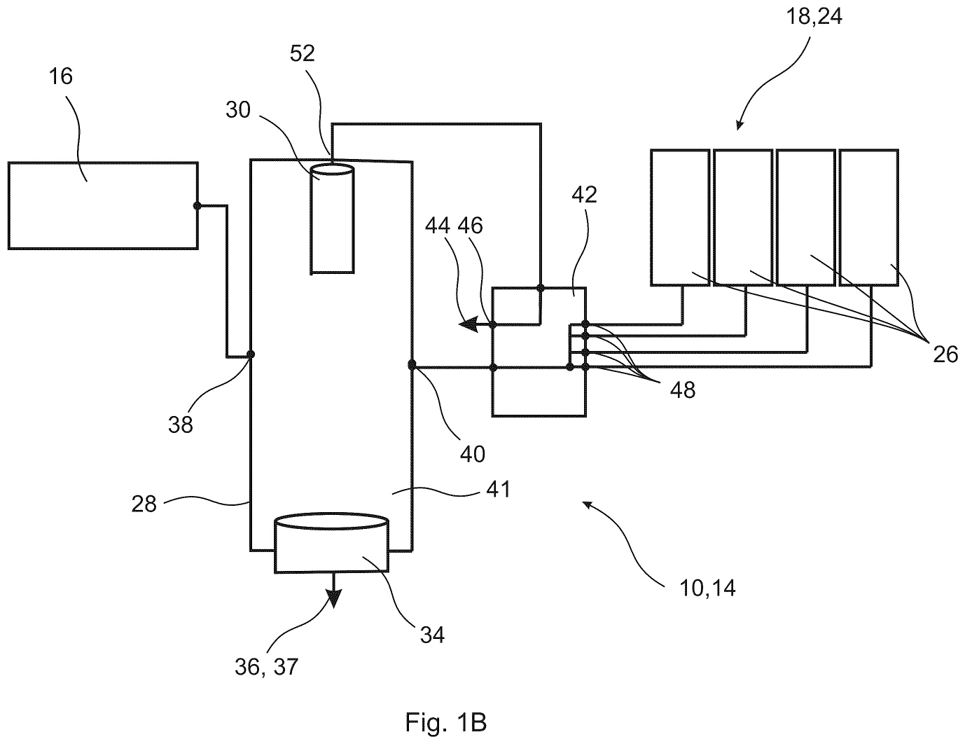

FIGS. 1A and 1B each show a greatly simplified schematic representation of an advantageous compressed air system 10. In the case of FIG. 1A, the compressed air system 10 is configured as an air spring system 12 and in the case of FIG. 1B as a compressed air-based sensor cleaning system 14.

The compressed air system 10 has a compressor device 16, in the present case in the form of a compressor, which is configured to generate compressed air to supply a downstream compressed air device 18.

In the case of the air spring system 12 shown in FIG. 1A, the compressed air device 18 is an air spring gallery 20 which has a plurality of, in the present case four, air springs 22 connected in parallel and fillable with the compressed air. Such an air spring system 14 may in particular be used in a motor vehicle to provide a leveling function. In the case of the sensor cleaning system 14 shown in FIG. 1B, the compressed air device 18 is a sensor arrangement 24 which has a plurality of sensors 26, such as for example optical, acoustic or radio-based sensors (camera, lidar, radar or the like) to which compressed air can be applied to clean away contamination. The compressed air-based sensor cleaning system 14 may also in particular be used in a motor vehicle, for example for traffic management and control as well as for example for parking and driver assistance systems.

For (temporarily) storing the compressed air, the compressed air system 10 furthermore has a compressed air reservoir 28 which in the present case is arranged between the compressor device 16 and the compressed air device 18 and interposed between these two apparatuses 16, 18. In other words, the compressed air reservoir 28 is arranged fluidically downstream of the compressor device 16 and series-connected with the compressor device 16.

In this way, the present compressed air system 10 differs significantly from compressed air systems known from the prior art in which one or more compressed air reservoirs are generally not connected in series with the corresponding compressor device, but in parallel with it.

The reason for the present particular arrangement of the compressed air reservoir 28 (connected not in parallel, but in series with the compressor device 16) is that it is advantageously provided in the present compressed air system 10 that the compressed air reservoir 28 has an air drying device 30 structurally integrated therein which is filled with a desiccant 32 for drying the compressed air or is substantially formed from the desiccant 32. The integration of the air drying device 30 in the compressed air reservoir 28 advantageously provided here offers the advantage that distinctly greater drying efficiency is achieved.

This is because in known compressed air systems, a corresponding air drying device conventionally takes the form of an independent component which is arranged immediately downstream of the compressor device. However, if the desiccant 32, usually silica desiccant pellets, is to function adequately, it is necessary for the temperature of the compressed air to be within a certain temperature range, conventionally 0-80° C. Since air is greatly heated on compression and the freshly generated compressed air usually has a distinctly higher temperature than the stated temperature range immediately on outflow from the compressor device 16, the conditions for optimum drying of the compressed air are often not achieved in the arrangement known from the prior art of an air drying device immediately following the compressor device. This is because, in addition to the usually suboptimal temperature of the compressed air, its residence time in the region of action of the air drying device is typically not long enough as the air flows through the air drying device comparatively quickly and can only interact with the desiccant and be dried over a relatively short period of time.

These disadvantages are considerably reduced in the case of integration of the air drying device 30 into the compressed air reservoir 28, as provided here. This is because, on the one hand, the compressed air has sufficient time while stored in the compressed air reservoir 28 to cool down to a temperature within the optimum temperature range of the desiccant 32. On the other hand, the compressed air remains within the compressed air reservoir 28 for a considerably longer period of time, such that it has sufficient time to interact with the desiccant 32. In addition, it is provided that the air drying device 30 is arranged outside a flowing region of the compressed air reservoir 28 from a compressed air inlet of the compressor device 16 to the air spring gallery 20 of the downstream compressed air device 18, in the present case, e.g., in a ceiling region, such that the flow velocity through the desiccant 32 is reduced and drying efficiency is thus increased.

The compressed air reservoir 28 furthermore has in the present case a moisture collection device 34 arranged at a bottom region of the compressed air reservoir 28. The moisture collection device 34 is configured to purposefully collect condensed moisture in the compressed air reservoir 28, in particular on the interior walls, and to drain it from the compressed air reservoir 28. In particular, the moisture collection device 24 can for this purpose be formed by a convex inner contour of the bottom region of the compressed air reservoir 28 or at least be arranged in the region of the convex bottom region.

In order to discharge or drain the collected condensed moisture from the compressed air reservoir 28, the moisture collection device 34 is controllably couplable to a dehumidification valve 36 and a dehumidification outlet 37 of the compressed air reservoir 28. The moisture collected in the moisture collection device 34 can be discharged from the compressed air reservoir 28 therethrough as required, i.e., in a controlled manner, e.g., into the atmosphere. In particular, the dehumidification valve 36 takes the form of a pressure relief valve which opens automatically, so dehumidifying the compressed air reservoir 28, when a definable pressure threshold is reached, for example when a certain amount of moisture is present within the compressed air storage tank 28 or when an overpressure is purposefully applied by the compressor device 16. The dehumidification valve 36 can also function as an overpressure safety valve.

The compressed air reservoir 28 furthermore has an inlet 38 for admitting the compressed air and an outlet 40 for releasing the compressed air. The inlet 38 and outlet 40 can each be opened and closed in controlled manner or as required such that the compressed air reservoir 28 has an interior space 41 for storing the compressed air which is fluidically decouplable from the surroundings and in which the air drying device 30 is arranged. For example, the inlet 38 and outlet 40 may each have a controllable valve for this purpose.

In the present case, it is provided that the air drying device 30 occupies no more than 30% of the interior space 41 in order to ensure an optimum ratio of storage capacity and air drying.

The compressed air reservoir 28 is controllably fluidically couplable to the compressor device 16 via the inlet 38. The compressed air reservoir 28 is in turn controllably fluidically couplable to the compressor device 18 via the outlet 40.

A controllable valve block 42 of the air spring gallery 20 is arranged between the outlet 40 and the compressed air device 18, via which the flow or stream of compressed air between the compressed air reservoir 28, the compressed air device 18 and a drain 44 connectable to the atmosphere is controllable. In this connection, compressed air from the compressed air reservoir 28 can be introduced by way of the valve block 42 into the compressed air device 18 or the components thereof (air springs 22, sensors 26) and compressed air present in the compressed air device 18 and in the compressed air reservoir 28 can be released into the atmosphere via the drain 44.

The valve block 42 has a series of valves for controlling the flow of compressed air. In the case of the air spring system 12 shown in FIG. 1A, there is, for example, a drain valve 46, via which the drain 44 or the atmosphere is couplable to the compressed air device 18 and/or the compressed air reservoir 28, a plurality of filling valves 48, via which the components (air springs 22, sensors 26) of the compressed air device 18 are fillable or pressurizable with compressed air and optionally compressed air present therein (in the case of air springs 22) is releasable, and a flow control valve 50, in the present case a 4/2 way valve, via which the direction of flow of the compressed air is controllable by appropriately connecting the compressed air reservoir 28, compressed air device 18, and drain 44.

The valve block 42 of the sensor cleaning system 14 shown in FIG. 1B has, similarly to the valve block of the air spring system 12 shown in FIG. 1A, the drain valve 46 and the filling valves 48, but not the flow control valve 48, such that in this case the valve block 42 only enables outflow of the compressed air stored in the compressed air reservoir 28 to the drain 44 and inflow of the compressed air into the sensor arrangement 24.

The primary function of releasing the compressed air directly from the compressed air reservoir 28 to the drain 44 is to actively enable regeneration of the desiccant 32. The desiccant 32 becomes saturated with moisture after a certain period of operation, such that it can no longer absorb any further moisture and is no longer able to fulfill its drying function. In this case, it is necessary to use compressed air to expel the moisture stored in the desiccant 32 therefrom and so regenerate the desiccant 32 or the air drying device 30. In the present compressed air system 10, this function is provided by the air drying device 30 being arranged in the region of a vent outlet 52 of the compressed air reservoir 28, via which the interior space of the compressed air reservoir 28 is connectable to the drain 44. Once the connection has been established, the compressed air stored in the compressed air reservoir 28 can flow through the air drying device 30 or its desiccant 32 toward the drain 44 and so absorb the moisture stored in the desiccant 32 and discharge it into the atmosphere via the drain 44.

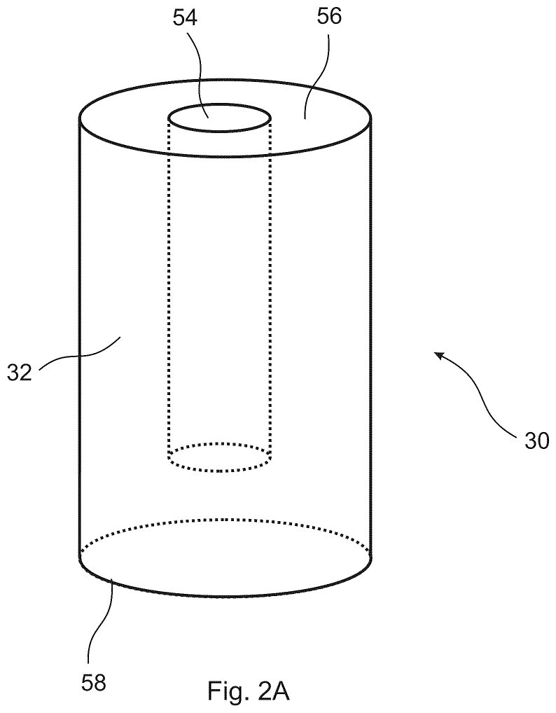

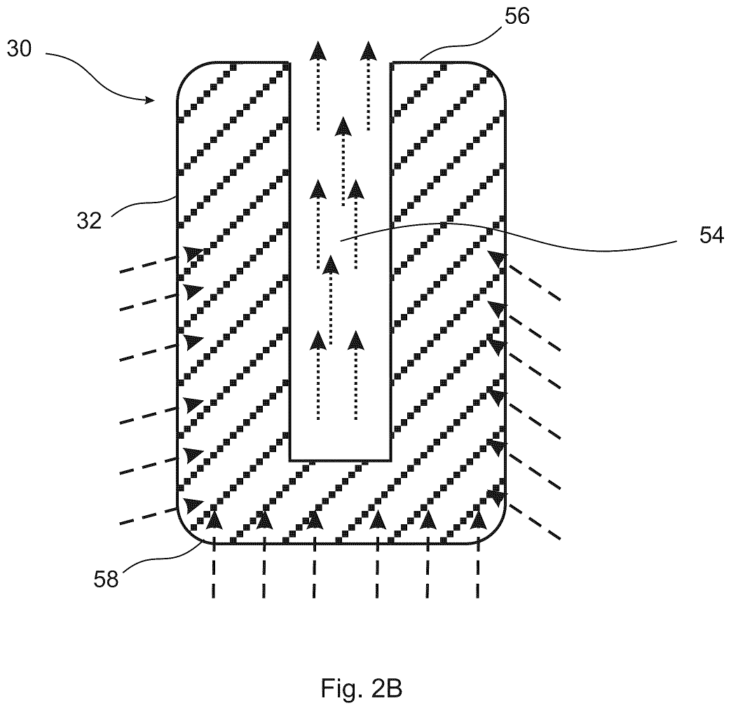

FIGS. 2A and 2B provide a more detailed illustration of the air drying device 30 which is advantageously structurally integrated into the compressed air reservoir 28. FIG. 2A is a simplified perspective representation of the air drying device 30 while FIG. 2B is a simplified cross-sectional representation.

As shown in FIG. 2A, in the present case the air drying device 30 is of cylindrical construction or is cylindrical in shape. An axially extending vent channel 54 arranged centrally or in centered manner is provided in the interior of the air drying device 30, which vent channel 54 is open to a cylinder upper side 56 of the air drying device 30 but closed to a cylinder underside 58 opposite the cylinder upper side 56, such that the vent channel 52 passes only partially through the air drying device 30. The vent channel 54 is connected to the vent outlet 52 in order to enable the (active) regeneration of the air drying device 30 described above.

In this connection, as is clearly apparent in FIG. 2B, there is no desiccant 32 in the vent channel 54. The remaining body of the air drying device 30, on the other hand, includes or is formed from the desiccant 32 such that, as shown by arrows in FIG. 2B, the compressed air can flow from outside into the air drying device 30 and so interact with the desiccant 32 for absorption of the moisture stored in the desiccant 32. The compressed air can subsequently flow out via the vent channel 54 with the moisture absorbed from the desiccant 32 via the vent outlet 52 to the drain 44 in order to enable regeneration of the air drying device 30 by outward transport of the moisture into the atmosphere.

In the present case, it is provided that the air drying device 30 is configured without a closed outer housing and is thus housing-free. To this end, the desiccant 32 can be press-molded or baked in order to form a predefined shape of the air drying device 30, in the present case a cylindrical shape. Alternatively, a shaping, air-permeable envelope, in particular a fine-meshed net or grating, may be provided, into which the desiccant 32 is introduced and/or arranged in a matrix manner. The housing-free configuration of the air drying device 30 advantageously enables simple and inexpensive production, wherein at the same time efficient drying of the compressed air is provided by enabling a large contact area and optimum permeability of the desiccant 32.

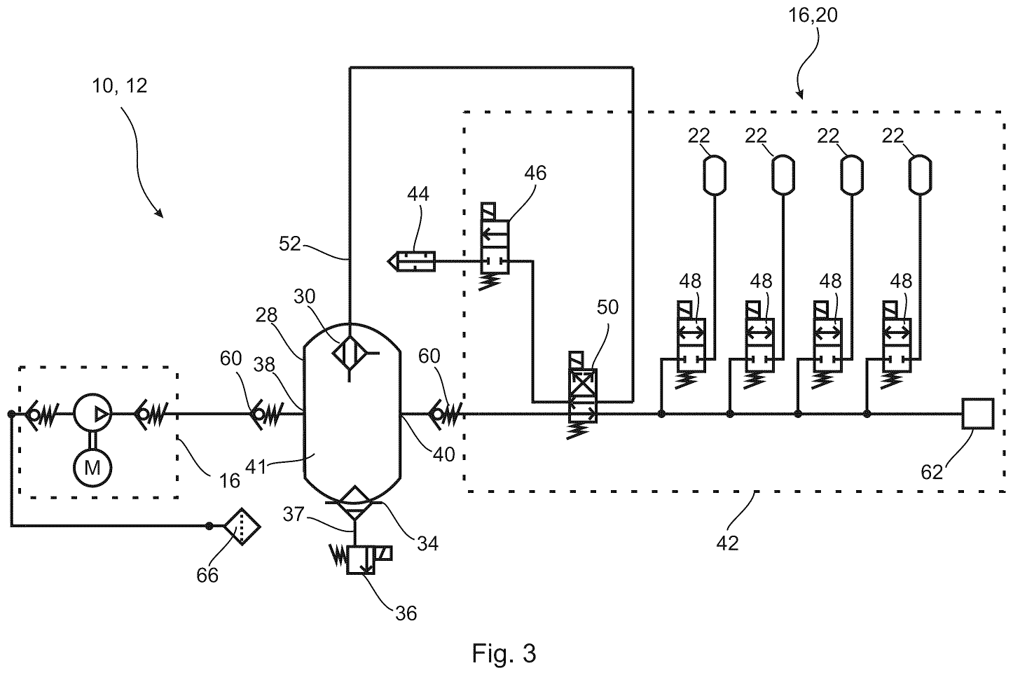

FIG. 3 shows a simplified circuit diagram of the air spring system 12 previously shown in FIG. 1A, wherein FIG. 3 shows the air spring system 12 in an initial state. As is readily apparent from FIG. 3, the compressor device 16, the compressed air reservoir 28, the air spring gallery 20 and the drain 44 are fluidically connectable to one another via corresponding lines and the valves 46, 48, 50 appropriately arranged within the valve block 42. In addition, a series of appropriately arranged nonreturn valves 60 is provided which prevent unintended backflow of the compressed air, in the present case back into the compressor device 16 and the compressed air reservoir 28. As FIG. 3 additionally shows, the air spring gallery 20 also includes, apart from the air springs 22, a pressure sensor 62 which can be used to check the air pressure currently prevailing in the air springs 22.

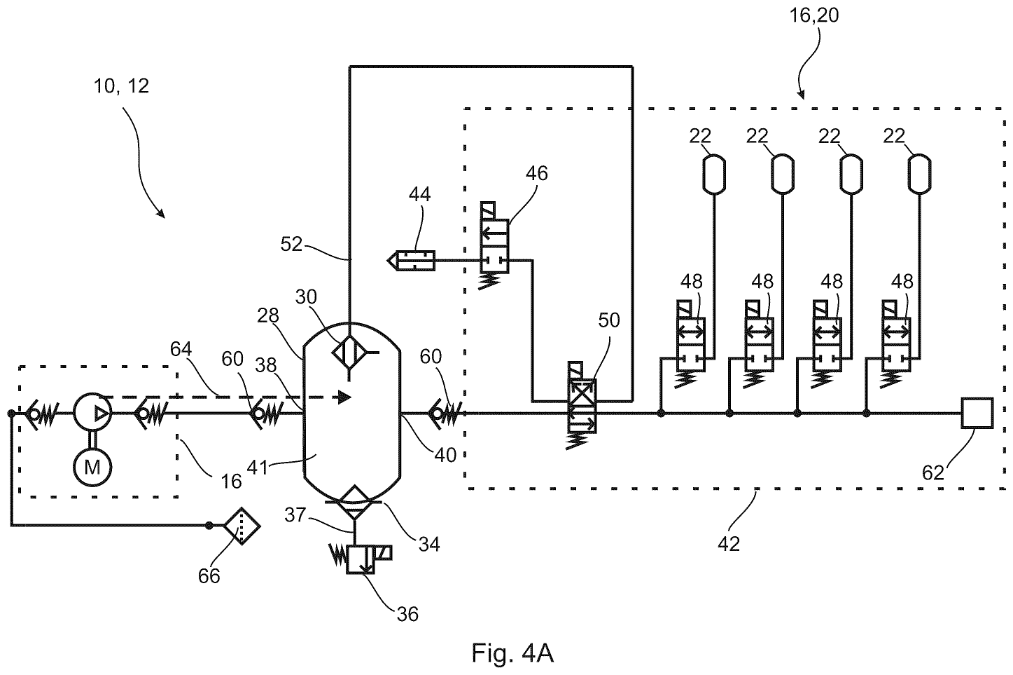

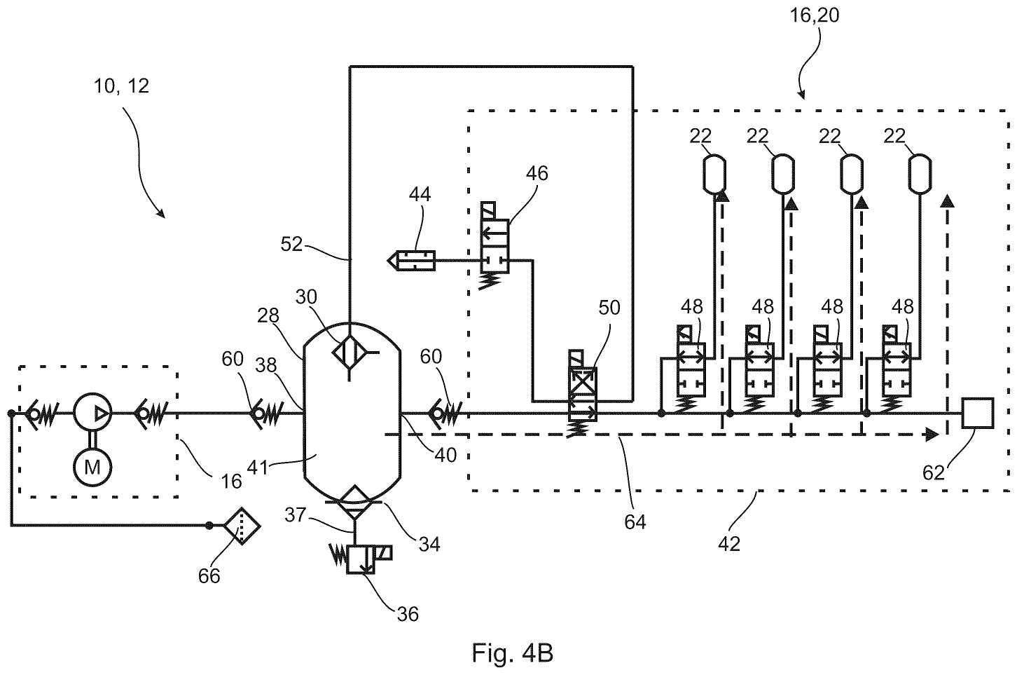

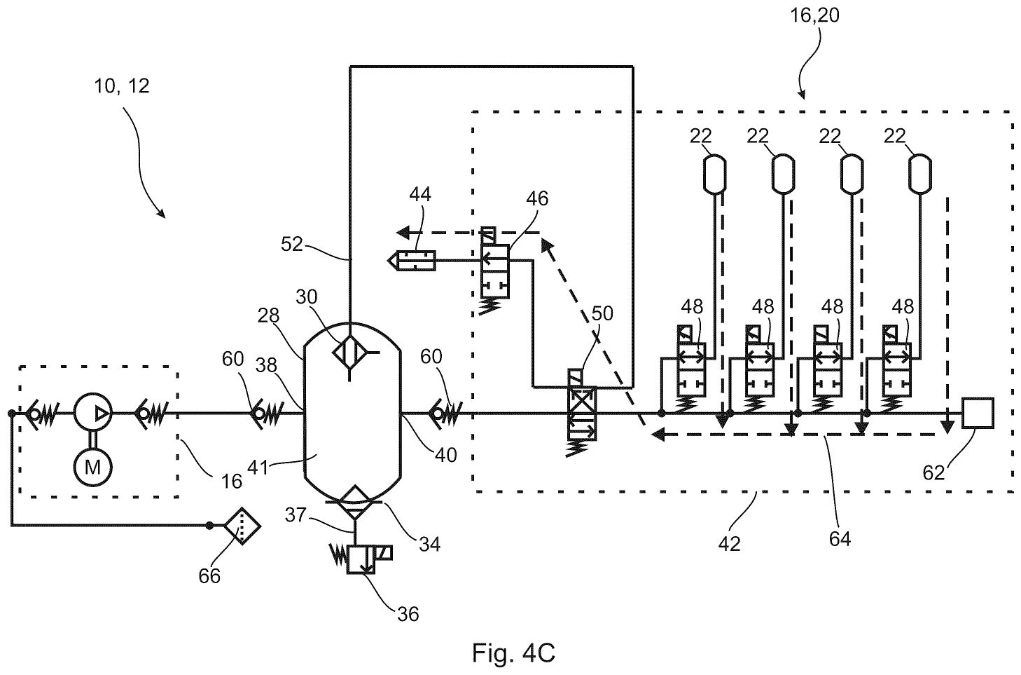

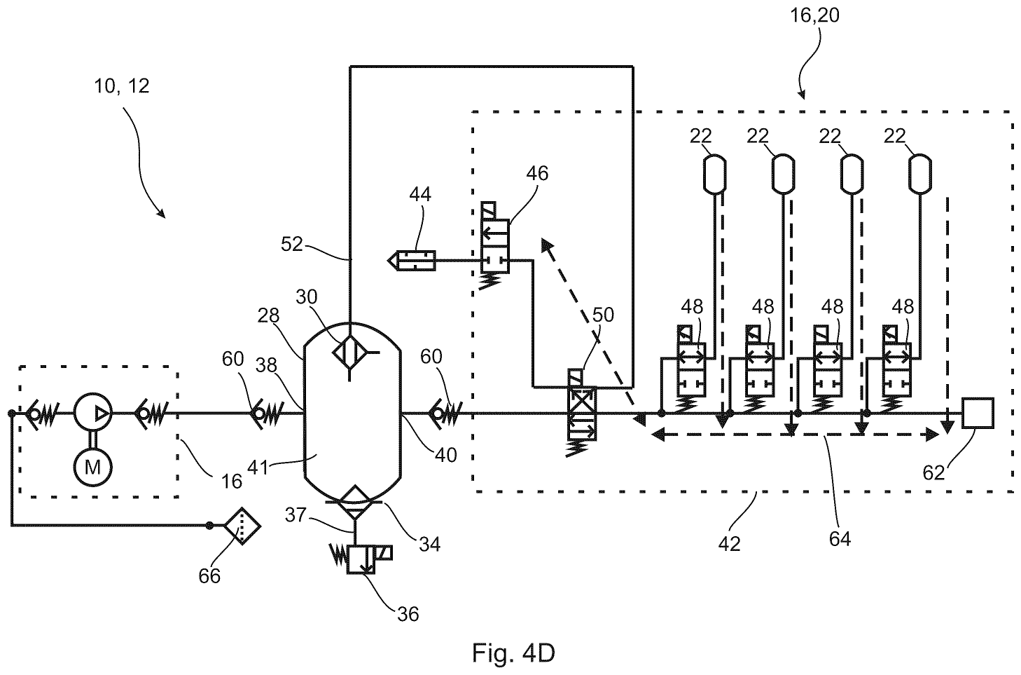

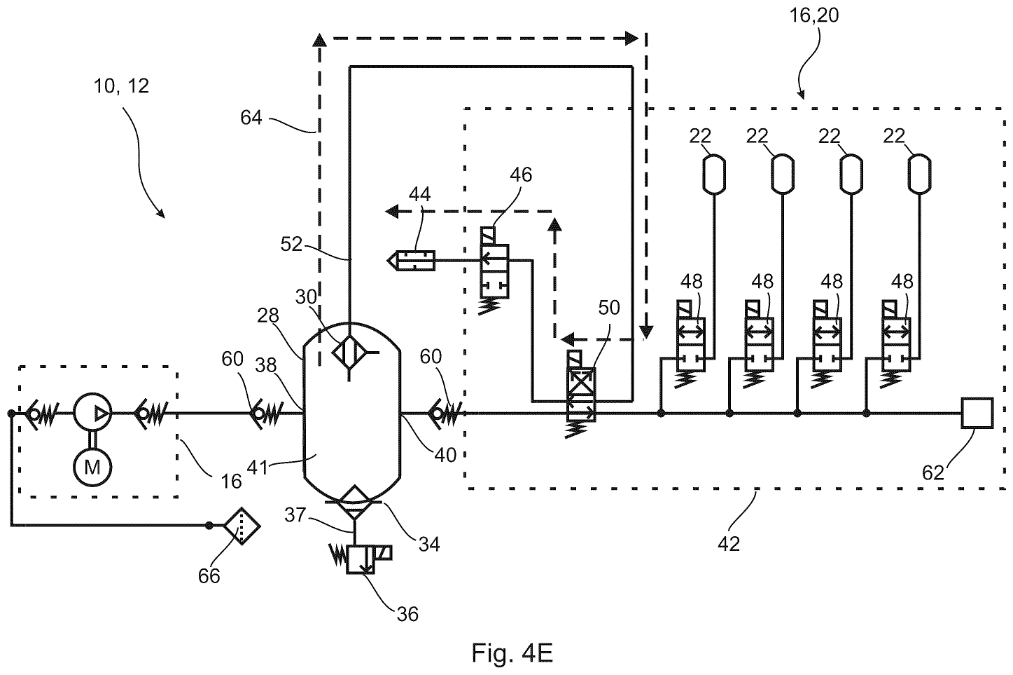

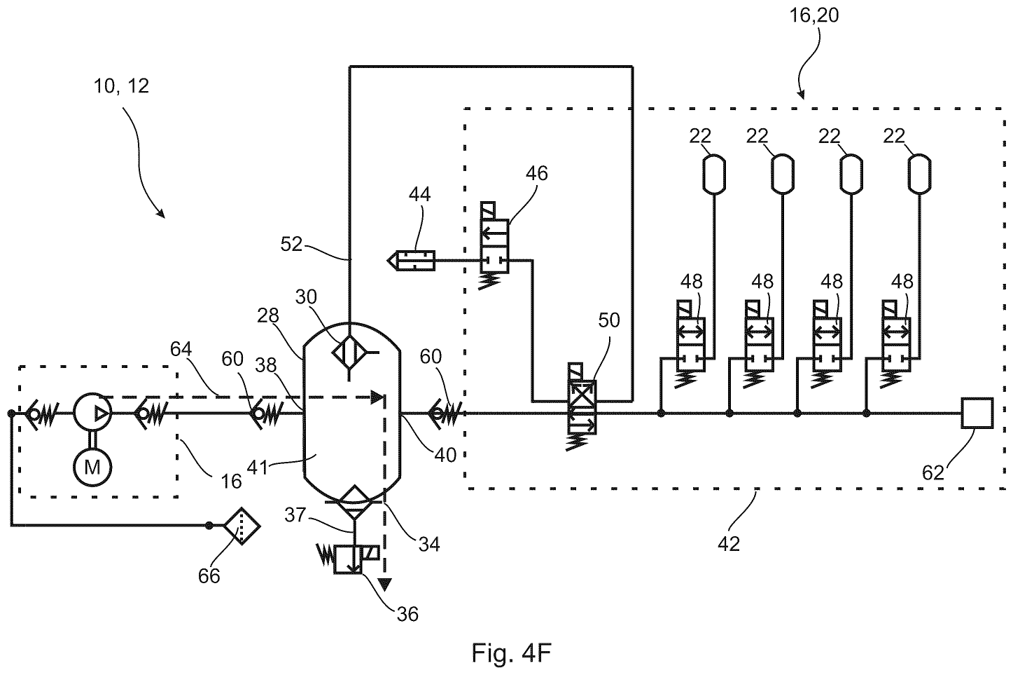

Similarly to FIG. 3, FIGS. 4A to 4F each show the circuit diagram of the air spring system 12, in each case during another operating state of the air spring system 12.

In the operating state shown in FIG. 4A, the compressed air reservoir 28 is being filled with compressed air generated by the compressor device 16, as depicted by a flow arrow 64. To this end, the compressor device 16 is operated such that air is aspirated from the surroundings via an atmospheric access 66 and compressed into compressed air by the compressor device 16. After compression, the compressed air is then delivered, as indicated by the flow arrow 64, from the compressor device 16 via the open inlet 38 into the compressed air reservoir 28, wherein backflow is prevented by the appropriately arranged or configured nonreturn valves 60. The other outlets of the compressed air reservoir 28, i.e., outlet 44, the dehumidification outlet 37 and the vent outlet 52, are closed at this point. In addition, the flow control valve 50 is in a first switching state, in which inflow of the compressed air from the compressed air reservoir 28 into the air spring gallery 20 through the flow control valve 50 is prevented, such that the compressed air remains stored in the interior of the compressed air reservoir 28.

FIG. 4B shows the air spring system 12 in an operating state in which the air springs 22 are being filled, as shown by flow arrows 64. To this end, the outlet 40 of the compressed air reservoir 28 is open while the dehumidification outlet 37, inlet 38, and vent outlet 52 are closed. Furthermore, within the valve block 52, the flow control valve 50 is in a second switching state in which inflow of compressed air from the compressed air reservoir 28 into the air spring gallery 20 is enabled. Furthermore, filling valves 48 of the valve block 42 associated in each case with an air spring 22 are open such that the compressed air which has flowed into the air spring gallery 20 can flow as far as into the air springs 22 and the latter are filled with compressed air. This enables the vehicle to be raised, in particular when the air spring system 12 is used in a motor vehicle. At the same time, the drain valve 46 is closed such that no compressed air can escape from the compressed air reservoir 28 into the atmosphere.

FIG. 4C shows the air spring system 12 in an operating state in which the compressed air present in the air spring gallery 20 or the air springs 22 is being released, as is again shown by the flow arrows 64. To this end, the filling valves 48 of the valve block 42 are open such that the compressed air can flow in and out of the air springs 22. The flow control valve 50 of the valve block 42 is furthermore in a third switching state in which inflow of the compressed air from the air spring gallery 20 or from the air springs 22 toward the drain 44 is enabled. The drain valve 46 of the valve block 42 is consequently open such that the compressed air can flow out from the air springs 22 via the valve block 42 to the drain 44 and onward into the atmosphere as intended. If the air spring system 12 is, for example, used in a motor vehicle, the motor vehicle is lowered by releasing the compressed air from the air springs 22.

FIG. 4D shows the air spring system 12 in an operating state in which the air pressure currently prevailing in the air springs 22 or the air spring gallery 20 is measured by way of the pressure sensor 62. This makes it possible to check whether the currently prevailing air pressure is sufficient for the intended use. The filling valves 48 are open for pressure measurement, so enabling inflow and outflow of the compressed air into or out of the air springs 22. The flow control valve 50 is in the third switching state in which flow of the compressed air from the air spring gallery 20 or air springs 22 toward the drain 44 is enabled. The drain valve 46 is closed such that the compressed air cannot flow out from the air spring gallery 20 or the air springs 22 into the atmosphere via the valve block 42, but instead circulates within the air spring gallery 20 where it is equilibrated. This prevents pressure loss within the air spring gallery 20. However, due to the filling valves 48 being open, the pressure sensor 62 is exposed to the compressed air at constant pressure such that the intended pressure measurement can be made.

FIG. 4E shows the air spring system 12 in an operating state in which the air drying device 30 is being regenerated, as is again shown by the flow arrows 64. To this end, the vent outlet 52 of the compressed air reservoir 28 is open, while outlet 40, dehumidification outlet 37 and inlet 38 and the filling valves 48 are closed. Within the valve block 42, the flow control valve 50 is in the second or a fourth switching state in which flow of the compressed air from the compressed air reservoir 28 toward the drain 44, and optionally flow of the compressed air from the compressed air reservoir 28 at least into an input region of the air spring gallery 20 is partially enabled. Since the filling valves 48 are closed and drain valve 46 is open, the compressed air ultimately flows from the compressed air reservoir 28 through the air drying device 30 into the atmosphere. In this way, as already discussed above, the air drying device 30 or the desiccant 32 is (actively) regenerated by the compressed air flowing from the compressed air reservoir 28 through the desiccant 32 and in so doing absorbing moisture stored in the desiccant 32, which moisture is ultimately transported outward via the drain 44 into the surrounding atmosphere.

Provision may optionally be made for the compressor device 16 additionally to be actively operated during the above-discussed regeneration process, in which case the inlet 38 of the compressed air reservoir 28 is correspondingly open. In this way, compressed air generated by the compressor device 16 is pumped into the compressed air reservoir 28 which thereupon-as described above-flows out through the air drying device 30 into the atmosphere. As a result, the air drying device 30 or the desiccant 32 can be constantly supplied and “flushed” with compressed air over an extended period such that the moisture stored in the desiccant 32 can be reliably and almost completely removed therefrom.

FIG. 4F shows the air spring system 12 in a state in which dehumidification of the compressed air reservoir 28, i.e., controlled release of the condensed moisture collected in the moisture collection device 34 from the compressed air reservoir 28, is taking place, as is again shown by flow arrows 64. To this end, the inlet 38 of the compressed air reservoir 28 and the dehumidification outlet 37 or the dehumidification valve 36 in the form of a pressure relief valve are open, while outlet 40 and vent outlet 52 are closed. In addition, the flow control valve 50 is ideally in the first switching state in which no compressed air can pass from the compressed air reservoir 28 into the air spring gallery 20 via the flow control valve 50. In order to open the dehumidification valve 36, the compressor device 16 is operated such that the compressed air reservoir 28 is filled with compressed air and an overpressure is generated within the compressed air reservoir 28. Once a definable pressure threshold has been reached, the dehumidification valve 36 opens, whereby the condensed moisture collected in the moisture collection device 34 is conveyed out of or can flow away from the compressed air reservoir 28 via the dehumidification outlet 37.

Additionally or alternatively, provision may be made for the compressor device 16 not to be operated and for only the dehumidification valve 36 to be opened to release the dehumidification outlet 37. This is in particular possible if the dehumidification valve 36 takes the form not of a pressure relief valve, but instead of a controllable valve, for example a solenoid valve. In this case, the condensed moisture collected in the moisture collection device 34 flows out of the dehumidification outlet 37.

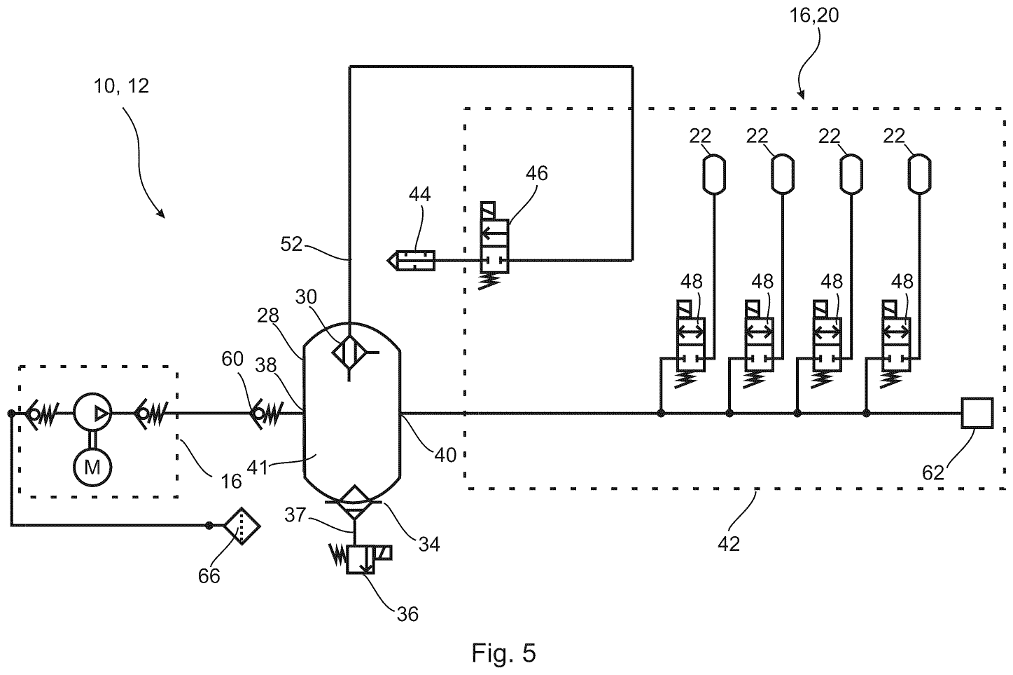

Similarly to FIG. 3, FIG. 5 shows a circuit diagram of the sensor cleaning system 14 described above with reference to FIG. 1B. In FIG. 5, the sensor cleaning system 14 is likewise in an initial state. As previously described, a plurality of the sensors 26 associated with the sensor arrangement 24 can be cleaned by applying compressed air from the compressed air reservoir 28 or directly applying compressed air freshly generated by the compressor device 16 to the sensor arrangement 24 in order to clean the sensors 26 or the sensor arrangement 24 as required. In the case of sensor cleaning, the outlet 40 and the filling valves 48 of the valve block 42 are opened such that the compressed air passes into the sensor arrangement 24 and compressed air is applied to the sensors 26 for cleaning. Optionally, the inlet 38 can additionally be opened and the compressor device 16 operated such that freshly generated compressed air is constantly supplied to the sensor arrangement 24 via the compressed air reservoir 28.

What is claimed is:

1. A compressed air reservoir for a compressed air system of a motor vehicle, the compressed air reservoir comprising:
a reservoir housing forming an interior space for storing compressed air which is controllably fluidically decouplable, via a valve, from a compressor, the reservoir comprising an air drying device structurally integrated into the compressed air reservoir and holding a desiccant for drying the compressed air.

2. The compressed air reservoir according to claim 1, wherein the air drying device occupies no more than 30% of a volume of the interior space of the compressed air reservoir.

3. The compressed air reservoir according to claim 2, wherein the air drying device is arranged in the interior space outside a throughflow region for the compressed air and/or within an air outflow path of a vent outlet of the compressed air reservoir.

4. The compressed air reservoir according claim 1, wherein the air drying device is cylindrical in shape and comprises at least one vent channel arranged axially and open toward a cylinder upper side and with a drying wall formed by a closed cylinder underside and by a radial cylinder outer wall.

5. The compressed air reservoir according to claim 1, wherein the air drying device is configured without a closed outer housing.

6. The compressed air reservoir according to claim 5, wherein the desiccant is press-molded or baked into a predefined shape.

7. The compressed air reservoir according to claim 5, wherein the desiccant is arranged in a matrix manner in a shaping, air-permeable envelope.

8. The compressed air reservoir according to claim 1, wherein the air drying device has an internally formed and axially arranged desiccant-free vent channel which is fluidically connected to a vent outlet of the compressed air reservoir.

9. The compressed air reservoir according to claim 8, wherein the vent channel is controllably fluidically couplable, by way of an outlet valve connected to the vent outlet of the compressed air reservoir, to an atmosphere located outside the compressed air reservoir.

10. The compressed air reservoir according to claim 1, wherein the compressed air reservoir comprises, at a bottom region, a corrosion-resistant moisture collection device for collecting condensed moisture from the air drying device, the corrosion-resistant moisture collection device is fluidically connected to a dehumidification outlet of the compressed air reservoir.

11. The compressed air reservoir according to claim 10, wherein the bottom region has a convex inner contour.

12. The compressed air reservoir according to claim 10, wherein the compressed air reservoir comprises a dehumidification valve that is controllably couplable to the moisture collection device such that the condensed moisture collected in the moisture collection device can be controllably discharged from the compressed air reservoir.

13. A compressed air system for a motor vehicle, comprising:
a compressor device for generating compressed air;
a compressed air reservoir fluidly coupled to the compressor device for at least temporary storage of the compressed air, the compressed air reservoir comprising a reservoir housing forming an interior space and an air drying device structurally integrated into the compressed air reservoir and holding a desiccant for drying the compressed air; and
a compressed air device fluidly coupled to the compressed air reservoir and/or the compressor device, the compressed air device configured to fill with compressed air.

14. The compressed air system according to claim 13, wherein the compressed air reservoir is fluidically interposed between the compressor device and the compressed air device.

15. A method for operating a compressed air reservoir, comprising:
generating compressed air by a compressor device;
transmitting the compressed air to the compressed air reservoir for at least temporary storage in the compressed air reservoir; and
drying the compressed air by a air drying device arranged within an interior space of the compressed air reservoir, wherein the interior space is defined by a reservoir housing of the compressed air reservoir, the air drying device is structurally integrated in the compressed air reservoir.

16. The method according to claim 15, further comprising flowing the compressed air through a vent channel of the air drying device toward an exterior atmosphere such that moisture stored in the air drying device is discharged from the air drying device into the atmosphere and a desiccant within the air drying device is regenerated.

17. The method according to claim 15, further comprising:
collecting moisture condensed in the compressed air reservoir in a moisture collection device arranged in a bottom region of the interior space, the bottom region is low in relation to the Earth's gravitational force, wherein the moisture collection device is coupled to a dehumidification valve; and
discharging the collected moisture by exposing the compressed air reservoir to overpressure to controllably transport the collected moisture to an exterior atmosphere via the dehumidification valve.
